(19) United States
(12) Patent Application Publication
(10) Pub. No.: US 2006/0153329 A1
(43) Pub. Date: Jul. 13, 2006

(54) Method for irradiating objects and device for carrying out said method

(76) Inventors: Sveta Lvovna Elyash, Sarov (RU); Nataliya Ivanovna Kalinovskaya, Sarov (RU)

Correspondence Address: LADAS & PARRY LLP, 224 SOUTH MICHIGAN AVENUE, SUITE 1600, CHICAGO, IL, 60604, US

(21) Appl. No.: 10/541,851

(22) PCT Filed: Jan. 9, 2004
(86) PCT No.: PCT/RU04/00007

§ 371 Date: Oct. 17, 2005

(30) Foreign Application Priority Data
Jan. 10, 2003 (RU) 2003100826

(51) Int. Cl. G21K 5/00

(52) U.S. Cl. 378/64

(57) ABSTRACT

The invention relates to radiation engineering. The inventive method for irradiating objects consists in generating the pulsed ionising radiation and exposing objects to the effect thereof. Said irradiation is carried out by an electron beam or X-rays such that said objects are subjected to the radiation treatment and sterilised. A type of radiation, treatment mode and irradiation field are selected using a set of replaceable sealed-off electron or X-ray tubes. The irradiation field is generated by one or more modules and by spatial handling of modules with respect to an irradiated object. The inventive method is carried out with a device for irradiating an object, comprising a power supply unit, control unit and high-voltage unit provided with a sealed-off electron or X-ray tube. The device further comprises a set of replaceable sealed-off electron and/or X-ray tubes and at least one module consisting of the high-voltage unit and a sealed-off electron and/or X-ray tube selected from the set. The body of the high-voltage unit is provided with at least one jack for fixing and replacing the sealed-off electron or X-ray tube provided with a standard mating unit.

### DESCRIPTION

The invention relates to radiation engineering, in particular—to the techniques for irradiating objects by a beam of accelerated electrons and by X-rays. The claimed method and device can be suitably used for executing the surface and 3D sterilization, for example for sterilization of the postal correspondence, medical instruments, implants and implanted materials, food packages in food industry, etc. The pulsed X-rays can be used in medicine for irradiating the donor blood, for example for transplanting the spinal cord, as well as in industries for irradiating the electronics equipment components in checking its resistance to radiation damage.

Known is a method for irradiating blood and a device for carrying out the same according to U.S. Pat. No. 6,212,255, publ. Apr. 3, 2001, with priority as of Aug. 28, 1999, IPC G 21 K 5/08, US NCI 378/66, titled “A system for X-raying the blood”. Said method for irradiating the blood comprises the step of providing the static X-ray radiation emitted by two X-ray tubes, between which tubes a plastic bag containing blood or blood-plasma is disposed. The resultant two-side irradiation provides the 3D uniform treatment of a container having a bag 4 cm thick by two X-ray tubes or one tube, the blood-containing bag being rotated. One tube provides dose of 25 Gy on the bag front surface, and 15 Gy—on the rear surface. The device includes the systems of: power supply, control; and two static X-ray tubes for voltage of 160 kV, with the incandescent cathode and cooled anode. The container for a plastic bag accommodating the blood is extended out of the device main housing. This device is moveable.

A disadvantage of said technical solution is its restricted functionality, for the method and device disclosed therein are intended only for irradiating blood and only by X-rays. Furthermore, said device comprises systems for evacuation and water cooling, and weighs 386 kg, having dimensions of 107×147×66 cm, i.e. this device is quite heavy and cumbersome.

The art most pertinent to the claimed invention are the method and device for irradiating objects, as disclosed in EP 0011414, having priority as of Nov. 3, 1978, publ. Jul. 20, 1983, IPC A61 L2/08, H01 J 37/00: “A method and device for irradiating surfaces by electron beam”. The method for irradiating objects according to this most pertinent art provides generation of the pulsed ionizing radiation, and exposure of objects thereto. The ionizing irradiation is an electron beam for effecting the surface sterilization of articles, mainly—food packages. This method for irradiating surface and intended for sterilization of batches of articles includes the steps of: periodically repeated generation of electric-discharge pulses, periodically repeated delivery of the electron beam pulses from the cold cathode through the anode's electron-permeable window, arrangement of the anode window near the zone portion along which the irradiated articles move. Resistance of the accelerating tube having the cold cathode is matched with that of the pulse generator circuit. Irradiation is done by electrons having maximum energy of 450 keV at most, and the surface dose per pulse of 50 kGy at most.

A disadvantage of this most pertinent art is in that its functionality is restricted, i.e. this method is capable of only the electron-aided surface sterilisation of the objects not larger than 4 cm.

According to said most pertinent art, the device for irradiating objects comprises a power supply unit, control unit, and a high-voltage unit having an accelerating tube. The high-voltage unit is the Marx generator and is disposed in a separate housing. Two cold cathodes are rigidly attached on a common high-voltage input. The device comprises vacuum pumps for continuous evacuation of the accelerating tubes. An irradiated object is disposed between two windows of the accelerating tube. The device is moveable.

Disadvantages of this device are its restricted functionality, because the device is able to provide the electron-aided surface sterilisation only of the objects not larger than 4 cm, and has quite large dimensions due to the presence of pumps. Dimensions of the device are about 60×60×100 cm.

This invention has been devised for providing a method for irradiating objects of different use by the X-ray beam or electron beam for various purposes, with a broad range of emitted doses and convenient switch-over from one mode to another. Development of the claimed device was aimed at providing a compact, autonomous, versatile irradiation means for radiation engineering.

The technical result to be attained by implementing and embodying the claimed method and device consists in an extended functionality and diminished dimensions of the device.

Said technical result is attained as follows: unlike the known method for irradiating objects and providing for generation of the pulsed ionizing radiation and exposing objects to said radiation—the novel feature of this invention consists in that the irradiation is effected by an electron beam or X-ray beam for the radiation treatment of objects, inclusive of sterilization; selection of a radiation type, treatment mode and irradiation field being enabled. This possibility is ensured by the presence of replaceable sealed-off electron and/or X-ray tubes. The irradiation field is generated by single module or a set of modules, the modules being handled spatially with respect to an irradiated object.

Objects are irradiated for the surface and 3D treatment by electrons and quanta having energy of 1 MeV at most.

When single module is used, the irradiation field is generated within the range of the radiation spot diameters in the tube window about 10-120 mm.

When single module is used, objects for the X-ray radiation treatment are irradiated within the range of maximum doses about 0.1-3.0 Gy per pulse, a required dose being obtained in the frequency mode.

Objects, for example blood and its components, are irradiated by the pulsed X-ray radiation, a required dose being obtained in the frequency mode.

When single module is used, objects, for their sterilization by the electron beam, are irradiated within the range of maximum doses about 5-50 kGy per pulse, a required dose being obtained in the frequency mode.

For sterilization of packages, for example, in particular—postal envelopes containing anthrax spores, objects are irradiated by electron beam and, additionally, by ozone generated by said beam within the closed space of packages.

For generation of the irradiation field, the modules are arranged, for example, at the opposite sides in respect of the treated object—to do the two-sided irradiation.

Said technical result also is achieved as follows: unlike the known device for irradiating objects and comprising a power supply unit, control unit and high-voltage unit with an accelerating tube—the claimed invention—s novel features consist in that the claimed device comprises a set of replaceable sealed-off electron tubes or X-ray tubes, and the high-voltage unit housing has at least one jack for replaceable securing a sealed-off electron or X-ray tube provided with a unified mating assembly.

The accelerating tube is electrically connected to the high-voltage unit via an additional current-conducting tubular element having a collet or thread on its ends.

Diameter d of the accelerating tube cathode and distance h between the cathode and the tube outlet window are designed for a set of the sealed-off electron and/or X-ray tubes, and obey the ratio of 1≦d/h≦3.5.

The housing and mating assembly are implemented as the conjugated bodies of revolution. The housing may have the cylindrical, conical, hemispherical or a combined shape.

Objects are irradiated by one of the two radiation types. Switch-over from the electron irradiation to X-ray irradiation is done by replacement of the electron tube with the X-ray one. The sealed-off electron or X-ray tube is replaced without evacuation or any complex handling, and takes a little time to arrange for a selected irradiation type. The known methods, as a rule, have a narrow purpose: either sterilization of one kind of articles or materials, or the radiation treatment of objects by X-rays. The claimed method is the multifunctional one: using required sealed-off electron or X-ray tubes of their set, by convenient fixing thereof in the high-voltage unit, selected is an irradiation type—the electron radiation or X-ray radiation, and the irradiation modes as well.

Objects can be irradiated not only on their surface as in the most proximate analogue, but spatially as well—both by electrons and X-ray quanta. The energy spectrum of electrons depends on a current and voltage pulse shape, and its limiting energy is 1 MeV at most. The softer spectrum mode, having limiting energy of 0.5-0.6 MeV, can be provided by the accelerating tube of the set, having a lower resistance, i.e. a larger cathode and smaller interelectrode gap. This results in a greater flux of electrons, and the spectrum becomes softer enabling a stronger surface dose, i.e. the surface sterilization is enabled. A harder spectrum, e.g. a spectrum having limiting energy of 1 MeV allows 3D sterilization of thin samples. For instance, the two-sided irradiation allows the 3D sterilization in 1-2 min of the objects several mm thick.

The energy spectrum of X-rays having limiting energy of quanta of 1 MeV at most allows—depending on a type of material and thickness of an irradiated object, upon selection of a suitable X-ray tube of the set—provide the even distribution of the required absorbed dose through thickness of several cm—in one-, or two-sided irradiation.

For generating the irradiation field, depending on an irradiated object size, a module (the high-voltage unit and tube), or several modules are selected to provide a required size of the radiation spot. In view of a required absorbed dose and needed treatment time, selected is a type of an accelerating tube having the optimum radiation spot diameter in the window within the range of 10-120 mm. This range is provided by accelerating tubes equipped with cathodes about 10-120 mm in diameter. One or more modules produce a required radiation spot area.

The matter of generating the irradiation field should also consider a material and thickness of an irradiated object, as well a required absorbed dose, and the nature of distribution of a dose within a treated object. When the even in-depth distribution of a dose is required, and a material is sufficiently dense, or its thickness is sufficiently great, then the two-sided irradiation may become reasonable, and in such case handling of modules would consist of their arrangement on the sides opposite to an object. In case an irradiated object is of a complicated configuration, then for the 3D treatment handling of modules may consist of arrangement of three, for example, modules in a manner that the tubes will be directed at angle of 120° with respect to each other. Thus, the irradiation field is generated by the spatial handling of any number of modules depending on a shape of an object.

Treatment by X-rays according to the claimed multifunctional irradiation method can be used for checking of resistance to radiation damage of microelectronics elements in the course of their manufacture. Small sizes of chips allow use the X-ray tubes of the set having the minimum cathode size of 10 mm and producing the maximum dose of 3 Gy per pulse. At that, a dose rate reaches 10⁹ Gy/s⁻¹. It is a great dose rate whereat failures of operation of chips may occur, so by testing them by single pulse at different distances from the tube window and thus varying a dose and its rate, resistance to radiation damage of the microelectronics components can be investigated.

In case of irradiating blood by X-rays, a size of a blood-containing bag will determine selection of X-ray tube having diameter of cathode of 120 mm. This tube will provide the maximum dose of 0.1 Gy per pulse. The absorbed dose of 15 Gy is obtained in 150 pulses. Thus, a size of an irradiated object and a required value of the absorbed dose determine selection of the tube that would provide the optimum maximum dose of X-rays per pulse within the range of 0.1-3 Gy.

The treatment by the electron beam can be used for sterilization of the irradiated objects. For example, in case of sterilization of the surgery suture material, i.e. a thread bundled in a skein 2-3 cm in diameter, the use of an electron tube having the cathode of 10 mm in diameter, which tube provides the dose of 50 kGy per pulse near the window, will be suitable. In the spot of 3 cm in diameter at distance of 2 cm from the window, the sterilizing dose of 25 kGy will be obtained in 1-2 pulses. If a skein has a considerable thickness, it should be irradiated at two sides.

For sterilization of postal envelopes, it would be reasonable to select the biggest electron tube provided with the cathode 120 mm in diameter to produce the dose of 5 kGy per pulse near the window. The sterilizing dose of 25 kGy can be provided on the rear side of a postal letter in 30 pulses. Thus, depending on sizes of an object, a required electron tube producing the maximum dose per pulse within the range of 5-50 kGy is selected.

It should be mentioned that ozone that exhibits a strong bactericidal activity, is generated from the air oxygen under the action of high-rate doses. According to the claimed method, the strong-current electron beam emitted from electron tubes produces in the air a dose rate reaching 10¹²-10¹³ Gy/s⁻¹ near the window. The relevant references teach (A. K. Piekayev, Contemporary radiation chemistry. Radiolysis of liquids and gases, M., “Na'ouka” publishers, 1986) that the maximum yield of ozone is provided with doses of 10⁹-10¹¹ Gy/s⁻¹. These conditions are created at the window of electron tubes in the air layer 1-2 cm thick. A package, an envelope for example, does not let the ozone escape from the irradiation zone quickly, so that its action in capacity of the sterilizing agent is prolonged.

The claimed device, that includes single module, is essentially a direct-action accelerator having a sealed-off electron or X-ray tube. The high-voltage unit design provides for the end-face or lateral disposition of the accelerating tube, for which purpose two identical jacks are implemented therein, one of which jacks is closed by a plug when the device is in operation. The accelerating tube's unified mating assembly allows the use, depending on a purpose, of any electron or X-ray tube of the set procured in view of an expected irradiation modes.

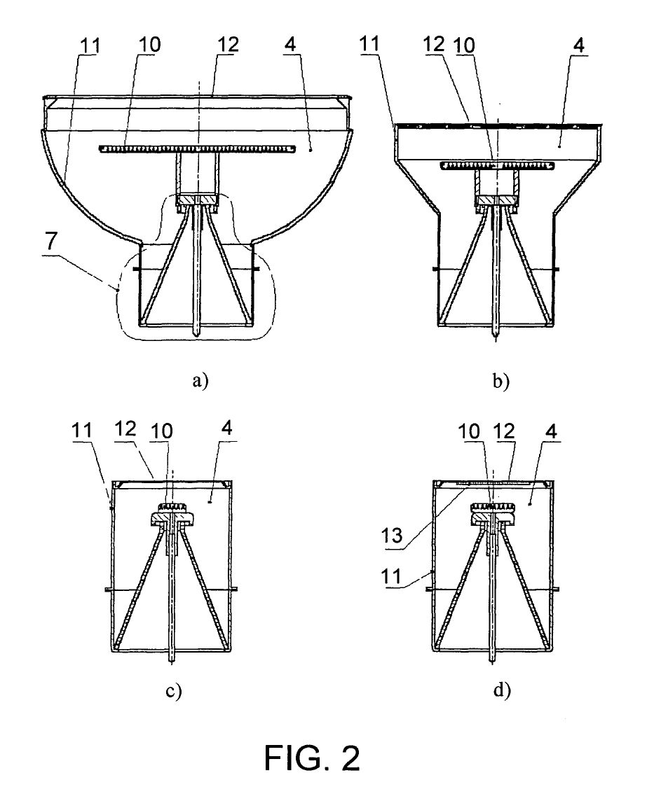

Main types of the tubes are shown in FIG. 2. Four sizes diameters d of cathodes and three sizes of housings provide 8 main types of tubes: 4 electron tubes and 4 X-ray tubes. By manufacturing the sealed-off electron or X-ray tubes having different values of h of the interelectrode gap, i.e. the distance from the cathode to the window or target, resistance of a tube may be further varied thus influencing the radiation spectrum hardness within each type of the tubes.

A means for electric connection of a tube to the high-voltage unit comprises a current-conducting tubular element having a collet or thread on its ends. This means is of a simple manufacture and is easily replaced. It further serves to protect a thin exhaust tube and its tip—the point where a tube is sealed-off. Inductance of this tubular element is less than that of the high-voltage unit's discharge circuit by an order of magnitude. Internal diameter of this element is determined by that of the accelerating tube's exhaust tube, which exhaust tube extends inside, and its outer diameter is selected in view of ensuring needed electric strength. Its length is determined by the distance from the tube cathode holder to the high-voltage unit output terminal.

The device allows irradiate objects of different sizes within the range of the irradiation spot diameters at the tube window about 10-120 mm, which is determined by parameter d, i.e. the cathode diameter. Depending on the purpose, i.e. depending on a required irradiation mode, parameter h, being the distance from the cathode to a target or the tube window, is selected. It is the d/h ratio that determines resistance of the accelerating tube, which resistance influences the current flowing through the tube, and influences the voltage therein. Diameter d of the accelerating tube cathode and distance h between the cathode and the tube outlet window are defined in conformity with a set of sealed-off electron and/or X-ray tubes according to ratio 1≦d/h≦3.5.

Compliance with this ratio provides a certain scope of resistances of the accelerating tubes in a set, which tubes represent the load of Marx generator. This scope of resistances in a set of sealed-off electron and/or X-ray tubes ensures the claimed ranges of irradiation modes, that is: dimensions of the irradiation field, maximum values of an irradiation dose per pulse, maximum energies of quanta and electrons. For example, for the X-ray tube having the cathode 90 mm in diameter (d=90) and the distance from the cathode to the tube window of 28 mm (h=28), the value of d/h=3.2 ratio is associated with range of 1 . . . 3.5. The maximum dose per pulse in this case is 60 cGy, and is within the claimed range of (0.1 . . . 3) Gy. The maximum energy of X-rays quanta of 950 keV also falls within the claimed range (up to 1 MeV). When d/h<1, the tube's resistance grows considerably, and the current diminishes, which results in a decrease in the maximum dose per pulse and in unacceptable long time of irradiation. When d/h>3.5, resistance of the tube decreases, and when a sufficiently strong current flows through the tube, the accelerating voltage therein may become so low that the energy of electrons will not suffice for passage through the window. The maximum dose per pulse diminishes, and the irradiation period grows unacceptably. The conducted experiments showed that ratio of 1≦d/h≦3.5 is the optimal one for the claimed device.

The housing and mating assembly of each one of the sealed-off electron or X-ray tubes of the set are implemented in the form of bodies of revolution, conjugated. The housing may have the cylindrical, conical, hemispherical or a combined shape. The unified mating assembly has a certain diameter of its cylindrical portion, for example—in a particular set of tubes this diameter is 69 mm. Diameter of the cathode in the set of tubes varies from 10 to 120 mm, and the tube window must have the diameter wider than that of the cathode. So that switch-over from the mating assembly to the outlet window is implemented in the form of two or more bodies of revolution (FIG. 2). In case of the minor-diameter cathodes, e.g. 10 or 25 mm, the housing is cylindrical, and its diameter is equal to that of the mating assembly's cylindrical portion. In case of large diameters of cathodes (e.g. in a particular set of tubes-50, 90 and 120 mm), the housing may be implemented as a combination of cylindrical and conical, or cylindrical and hemispherical shapes.

Thus the claimed invention allows vary smoothly the irradiation conditions in required limits, depending on an intended purpose, and is a multifunctional one, which features are provided by manufacture, selection and replacement of tubes.

The method and device are an alternative to the gamma-radiation and to the isotope-source devices. The claimed device is operated from mains-220 V and 50 Hz. Radiation hazard occurs only when the device is turned on. Operation of an electron or X-ray tube does not require any water cooling or evacuation means. The whole device, inclusive of one or more modules, a power-supply unit and control unit, is the portable one. Weight of the device having single module is 74 kg (without shield). Dimensions of a module are 38×84×30 cm at most, and those of the power supply-510×34×26 cm. The biological protection is local and represents a leaden chamber wherein an irradiated target is placed, and a projecting portion of a tube.

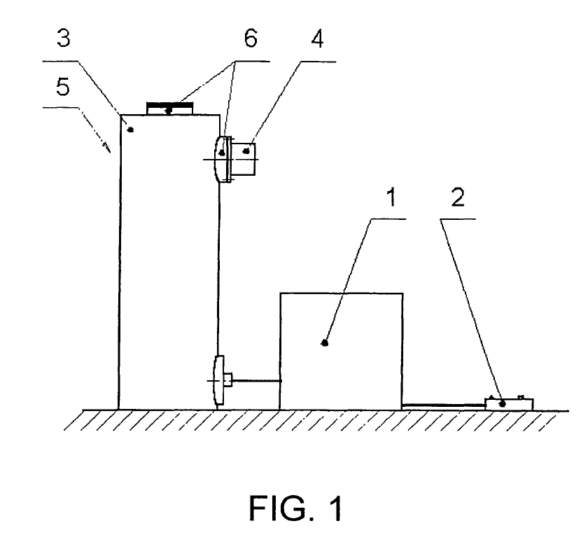

FIG. 1 shows the claimed device for irradiating objects and realization of the claimed method, comprising single module.

FIG. 2 shows main types of accelerating (electron and X-ray) tubes that may be included into a set and provide the electron and/or X-ray irradiation in different modes.

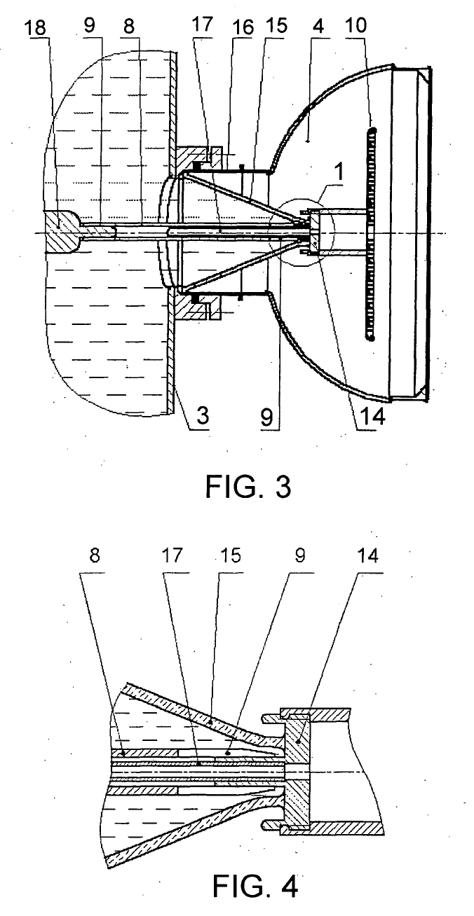

FIG. 3 shows connection of the accelerating tube with the high-voltage unit.

FIG. 4 shows connection of the tubular element with the cathode holder.

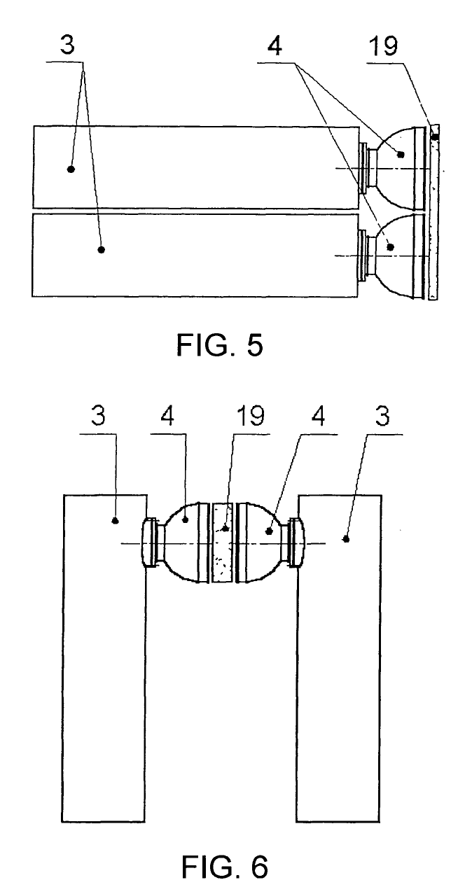

FIG. 5 shows an example of realization of the claimed method in one-sided irradiation of an object, for example—a letter; two modules have the end-face arrangement of tubes.

FIG. 6 shows an example of realization of the claimed method; an object is irradiated by two modules, with the lateral arrangement of the tubes.

The device for irradiating objects comprises power supply unit 1, control unit 2, high-voltage unit 3 insulated by oil, accelerating tube 4. The device comprises at least one module 5, including high-voltage unit 3 and sealed-off electron or X-ray tube 4. The high-voltage unit 3 housing has at least one jack 6 for replaceable fixing of sealed-off electron or X-ray tube 4, in which tube unified mating assembly 7 is provided.

The irradiating device comprises a set of sealed-off electron or X-ray tubes 4. Accelerating tube 4 is electrically connected to high-voltage unit 3 via additional current-conducting tubular element 8 having collet 9 or thread on its ends.

Furthermore, types of accelerating tubes according to FIG. 2 include sealed-off electron and/or X-ray tubes 4 having different sizes of cathodes, windows and housings. Each tube is the sealed-off one, which means that when being manufactured the same is evacuated and maintains vacuum when operated. A tube is a vacuum diode having cold cathode 10. The anode consists of the earthed cylindrical metallic portion of unified mating assembly 7, housing 11 and window 12 to emit radiation. The X-ray tube further comprises internal target 13 made of a material having a great atomic number. Unified mating assembly 7 according to FIGS. 2, 3, 4 comprises cathode holder 14, conical glass insulator 15, cylindrical portion 16 of the tube housing and exhaust tube 17, wherethrough a tube was evacuated. The electrical connection of high-voltage output terminal 18 of high-voltage unit 3 to cathode 10 of accelerating tube 4 is implemented using additional current-conducting connecting tubular element 8 having collet 9 or thread on its ends. Collet 9 surrounds high-voltage output terminal 18 and the stem of the cathode holder 14, FIG. 4.

The claimed operation is operated as follows. Power supply unit 1 is connected to mains of 220 V. Control unit 2 causes charging of capacitors of power supply unit 1; when “start” button is pressed, a controlled discharger accommodated in the power supply unit is activated and discharges the power supply unit's storage capacitors to the primary winding of a pulsed transformer in high-voltage unit 3. The voltage pulse from the transformer secondary winding charges the storage capacitors in the Marx cascade generator. When the breakdown voltage is achieved in the first cascade discharger, then dischargers of further cascades are consecutively activated to generate the high-voltage pulse in the accelerating tube connected to the high-voltage unit output via additional current-conducting connecting tubular element 10. Across the cathode the explosive electron emission occurs, and electrons under the action of the accelerating voltage move to the anode (window) of the accelerating tube, and the electrons pass through the electron tube window to the atmosphere and impinge upon the irradiated object, being absorbed therein and creating a required absorbed dose in a required number of pulses. If the X-ray tube is the case, the accelerated electrons are absorbed by the internal target, and the resultant X-ray quanta exit through the window into atmosphere and affect the irradiated object, thus creating a required absorbed dose in certain number of pulses.

The accelerating tube is replaced as follows. The high-voltage unit is disposed such that the tube window will be horizontal and directed upwards. First, the flange clamping the sealing rubber gasket is released, and then the tube is removed. The current-conducting element, provided with collets on its ends, is fixed onto the cathode holder of a new tube. Then the tube together with the current-conducting tubular element is inserted into the high-voltage unit such that the second collet would surround the high-voltage unit output terminal. Then the sealing flange is clamped. After the space beneath the accelerating tube's conical insulator has been filled with oil, this module will be ready for operation.

FIG. 5 shows an example of carrying out the claimed method for irradiating objects. The pulsed ionizing radiation is generated in the form of the electron beam for sterilization, for example—for sterilization of postal envelopes containing a letter. A standard envelope having size of 11×22 cm and containing three thrice-folded stationary paper sheets (11 layers of paper in total) is irradiated by the electron beam. The limiting energy of electrons is 1 MeV. This irradiation in 20 seconds produces the sterilizing dose of 20 kGy on the rear surface of the envelope under the action of the one-side irradiation. In this case, the electron tube having the cathode 12 cm in diameter is selected for operation among the set of accelerating tubes. Sterilisation can be carried out using single module, by moving the envelope with respect to the tube window (two positions of the envelope), or using the two positioned side by side modules (one position of the envelope). Ozone is generated within the envelope, and this ozone is the additional sterilising agent.

FIG. 6 shows another example of embodiment of the claimed method for irradiating objects, and irradiated is a bag containing the donor blood. A cassette 4 cm thick, made of thin plastic and comprising the blood-containing bag, is disposed between windows of two accelerating tubes of two modules of the claimed device. In this case, used are the X-ray tubes having cathode of 12 cm in diameter. The X-ray energy spectrum having limiting energy of 1 MeV, when the two-side radiation is used, enables the even distribution of the dose absorbed in the blood through the bag thickness. Dose of 15 Gy required for preventing any complications in transplanting is provided in less than 5 min.

Thus, the claimed method and device for irradiating objects, unlike the most pertinent art, is the multifunctional one, has a broad range of parameters of the X-ray and electron radiation dose, and of dimensions of the irradiated objects.

The device is multifunctional and compact, and can be placed on an office desk. The surface area occupied by such device having single module is about 1.5 times smaller as compared with its prototype.

1. A method for irradiating objects, comprising the steps of generating the pulsed ionizing radiation, and of exposing objects to the action of said radiation;
wherein the radiation is carried out by electron beam or X-rays for the purpose to subject objects to the radiation treatment, inclusive of sterilization; said method provides a possibility of selecting an irradiation type, treatment mode and irradiation field, which possibility is provided by the use of a set replaceable sealed-off electron and/or X-ray tubes; the irradiation field being generated by single module or a set of modules, and by spatial handling of the modules with respect to an irradiated object.

2. The method as claimed in claim 1, wherein objects are irradiated for their surface and 3D treatment by electrons or quanta having energy of up to 1 MeV.

3. The method as claimed in claim 1, wherein in case of use of single module, said irradiation field is generated within the range of the radiation spot diameters from 10 to 120 mm.

4. The method as claimed in claim 1, wherein objects for their radiation treatment with X-rays, when single module is used, are irradiated within the range of maximum doses of 0.1-3 Gy per pulse, a required dose being obtained in the frequency mode.

5. The method as claimed in claim 1, wherein objects, blood or its components for example, are irradiated by the pulsed X-rays, a required dose being obtained in the frequency mode.

6. The method as claimed in claim 1, wherein objects for their sterilization with electron beam, when single module is used, are irradiated within the range of maximum doses of 5-50 kGy per pulse, a required dose being obtained in the frequency range.

7. The method as claimed in claim 1, wherein objects, for example for sterilization of packages, in particular—postal envelopes containing anthrax spores, are irradiated by electron beam and, additionally, by the ozone generated by said beam within the closed space of packages.

8. The method as claimed in claim 1, wherein for the purpose of generation of the field for the two-sided irradiation, the modules are arranged, for example, at the opposites sides of the treated object.

9. A device for irradiating objects, comprising a power supply unit, control unit and high-voltage unit having a sealed-off electron or X-ray tube, wherein said device comprises a set of replaceable sealed-off electron and/or X-ray tubes or at least one module including a high-voltage unit and sealed-off electron or X-ray tube of the set; the high-voltage unit housing being provided with at least one jack for replaceable fixing of a sealed-off electron or X-ray tube, in which tube an unified mating assembly is implemented.

10. The device as claimed in claim 9, wherein the electrical connection of the sealed-off electron or x-ray tube to the high-voltage unit is implemented using an additional current-conducting element having a collet or thread at its ends.

11. The device as claimed in claim 9, wherein diameter d of cathode of the electron or X-ray tube, and distance h between the cathode and the tube outlet window are of the design to conform with a set of sealed-off electron and/or X-ray tubes according to the ratio of 1≦d/h≦3.5.

12. The device as claimed in claim 9, wherein the housing and mating unit of each one of said sealed-off electron or X-ray tubes of said set are implemented as bodies of revolution and are conjugated.
